(19) United States
(12) Patent Application Publication
(10) Pub. No.: US 2026/0063884 A1
(43) Pub. Date: Mar. 5, 2026

(54) METHOD AND AN APPARATUS FOR GENERATING REFLECTIVE DARK FIELD ILLUMINATION FOR A MICROSCOPE

(71) Applicant: Wise Device Inc., Richmond Hill (CA)

(72) Inventors: Aleksey Lopatin, Richmond Hill (CA); Alexis Davy Jean-Yves Renaud, North York (CA)

(21) Appl. No.: 19/295,000

(22) Filed: Aug. 8, 2025

Related U.S. Application Data
(60) Provisional application No. 63/687,703, filed on Aug. 27, 2024.

(51) Int. Cl. G02B 21/10

(52) U.S. Cl. CPC G02B 21/10

(57) ABSTRACT

A method and an apparatus for generating reflective dark field (RDF) illumination for a microscope are provided. The apparatus may include: one or more RDF illumination light sources positioned to emit light beams substantially orthogonal to a microscope optical axis; and multiple beam directing assemblies positioned at substantially identical optical axis distances from an RDF port of a bright field/dark field (BD) objective lens of the microscope. The multiple beam directing assemblies may be positioned to redirect emitted light received from the RDF illumination light sources into the RDF port to form a hollow light cylinder around the microscope optical axis, wherein the hollow light cylinder is diverted towards a microscope field of view (FOV) by an internal light diverting element (ILDE) of the microscope positioned within the RDF port.

### CROSS-REFERENCE TO RELATED APPLICATION

This application claims the benefit of U.S. Provisional Patent Application No. 63/687,703 filed Aug. 27, 2024, and the entire content of U.S. Provisional Patent Application No. 63/687,703 is incorporated by reference herein.

### FIELD

This document generally relates to a method and an apparatus for generating illumination for a microscope. Specifically, this document relates to a method and an apparatus for generating reflective dark field (RDF) illumination for a microscope.

### BACKGROUND

RDF modality is a powerful tool that is widely used in modern microscopy for observation and inspection of specimens. The RDF modality is utilized in a broad range of industrial microscopy applications, including, for example, electronic wafers production, bio-medical instruments etc.

RDF modality can enable reliable imaging for objects with sizes much smaller than the optical resolving power of the microscope. Further, the RDF modality is well-suited for inspection of optically non-transparent specimens. The RDF modality does not require positioning of any microscope components under the specimen. This can provide an advantage compared with other modalities that require additional microscope components to be positioned under the specimen.

In the RDF modality, a specimen is obliquely illuminated with light, so that the illumination light does not enter into the microscope imaging system directly. If the illuminated specimen doesn't contain any defects or objects of interest, inside the field of view (FOV) of the microscope, that can scatter, reflect or diffract the illumination light towards the imaging system of the microscope, then none of the light reaches the imaging device/eye of a microscope user. The observed FOV appears dark in this case. If the illuminated specimen contains any defects or objects of interest inside the FOV of the microscope, the defects/objects may redirect certain amount of the illumination light towards the imaging system of the microscope. These objects will appear to the microscope user's eye or to the microscope imaging device as bright areas on a dark background.

An efficient RDF illuminator should create high illuminance uniform light distribution in the FOV of the microscope and a low RDF image background. The scattered light intensity may generally depend on the shape of an illuminated object. To achieve identical RDF images intensities for the same object, placed in the FOV of the microscope in different azimuthal orientations, the RDF illuminator should illuminate the FOV of the microscope from all azimuthal directions with respect to the microscope optical axis. Such type of illumination is generally referred to in the field as “360° all around” illumination.

A common way to create “360° all around” illumination in RDF microscopy is to use specially designed built-in RDF illuminators and bright field/dark field (BD) objective lenses. The built-in RDF illuminators can generate a hollow cylinder of light that propagates along the optical axis of the microscope and is injected into the BD objective RDF port. The BD objectives can include internal light diverting elements (ILDEs) inside the RDF port. The ILDEs may include, for example, ring condensers, parabolic mirrors. The ILDEs can redirect the incoming hollow cylinder of light towards the FOV of the microscope to achieve “360° all around” illumination of the specimen under oblique angles.

For many applications, it may be desirable that switching between RDF and other microscope modalities would not require any mechanical displacement of microscope components. In some applications, it may be desirable that RDF modality can be engaged simultaneously with other microscope modalities.

### SUMMARY

The following summary is provided to introduce the reader to the more detailed discussion to follow. The summary is not intended to limit or define any claimed or as yet unclaimed invention. One or more inventions may reside in any combination or sub-combination of the elements or process steps disclosed in any part of this document including its claims and figures.

According to some aspects, an apparatus for generating RDF illumination for a microscope is provided. The apparatus may include: one or more RDF illumination light sources positioned to emit light beams substantially orthogonal to a microscope optical axis; and multiple beam directing assemblies positioned at substantially identical optical axis distances from an RDF port of a bright field/dark field (BD) objective lens of the microscope. The multiple beam directing assemblies may be positioned to redirect emitted light received from the RDF illumination light sources into the RDF port to form a hollow light cylinder around the microscope optical axis, wherein the hollow light cylinder is diverted towards a microscope field of view (FOV) by an internal light diverting element (ILDE) of the microscope positioned within the RDF port.

According to some aspects, a method of generating RDF illumination for a microscope is provided. The method may include: positioning one or more RDF illumination light sources to emit light beams substantially orthogonal to a microscope optical axis; positioning multiple beam directing assemblies at substantially identical optical axis distances from an RDF port of a bright field/dark field (BD) objective lens of the microscope to redirect emitted light received from the RDF illumination light sources into the RDF port to form a hollow light cylinder around the microscope optical axis; and powering the one or more RDF illumination light sources to generate the hollow light cylinder, wherein the hollow light cylinder is diverted towards a microscope field of view (FOV) by an internal light diverting element (ILDE) of the microscope positioned within the RDF port.

### BRIEF DESCRIPTION OF THE DRAWINGS

The drawings included herewith are for illustrating various examples of methods and apparatuses of the present specification and are not intended to limit the scope of what is taught in any way. In the drawings:

FIG. 1A is a schematic diagram of a microscope RBF illuminator known in the art.

FIG. 1B is a cross-sectional view of the illumination pattern of the microscope RBF illuminator of FIG. 1A.

FIG. 2A is a top-view schematic diagram of an apparatus for generating RDF illumination for a microscope, in accordance with one or more embodiments.

FIG. 2B is a side-view schematic diagram of the apparatus of FIG. 2A.

FIG. 3 is a schematic diagram of a light source of the apparatus of FIG. 2A, in accordance with one or more embodiments.

FIG. 4 is a schematic diagram of a light source of the apparatus of FIG. 2A, in accordance with one or more embodiments.

FIG. 5 is a top-view schematic diagram of an apparatus for generating RDF illumination for a microscope, in accordance with one or more embodiments.

FIG. 6 is a top-view schematic diagram of an apparatus for generating RDF illumination for a microscope, in accordance with one or more embodiments.

FIG. 7 is a side-view schematic diagram of an apparatus for generating RDF illumination for a microscope, in accordance with one or more embodiments.

FIG. 8A is an RDF image of a chromium-on-glass strip acquired using an example embodiment of the apparatus of FIG. 6 to generate the RDF illumination.

FIG. 8B is a graph showing unedited RDF image intensity distribution along a line drawn through the RDF image of the chromium-on-glass strip of FIG. 8A.

FIG. 9 is a side-view schematic diagram of an external light diverting element (ELDE) attached to a microscope BD objective of the microscope of FIG. 2A, in accordance with one or more embodiments.

FIG. 10 is a graph showing examples of acquired and theoretical RDF image intensity distributions for images acquired using an example embodiment of the apparatus for generating RDF illumination for a microscope.

FIG. 11A is an example image of a holographic diffuser acquired using an example embodiment of the apparatus for generating RDF illumination for a microscope, the example embodiment not including an ELDE attached to the microscope.

FIG. 11B is an example image of the holographic diffuser of FIG. 11A acquired using an ELDE attached to the example embodiment of the apparatus for generating RDF illumination for a microscope.

FIG. 12 is a graph showing image intensity distributions along a diagonal of the example images of FIGS. 11A and 11B.

FIG. 13 is a flowchart showing a method of generating RDF illumination for a microscope, in accordance with one or more embodiments.

### DETAILED DESCRIPTION

Numerous embodiments are described in this application and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

As used herein and in the claims, a group of elements are said to ‘collectively’ perform an act where that act is performed by any one of the elements in the group, or performed cooperatively by two or more (or all) elements in the group.

As used herein and in the claims, a first element is said to be “received” in a second element where at least a portion of the first element is received in the second element unless specifically stated otherwise.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112₁, 112₂, and 112₃). All elements with a common base number may be referred to collectively or generically using the base number without a suffix (e.g., 112).

As used herein and in the claims, “up”, “down”, “above”, “below”, “upwardly”, “vertical”, “elevation” and similar terms are in reference to a directionality generally aligned with (e.g., parallel to) gravity. However, none of the terms referred to in this paragraph imply any particular alignment between elements. For example, a first element may be said to be “vertically above” a second element, where the first element is at a higher elevation than the second element, and irrespective of whether the first element is vertically aligned with the second element.

Many industrial microscopy applications may require high inspections speeds (i.e., short inspection times). High inspection speeds can be achieved by providing relative movement between the microscope and the inspected specimen. A scanning microscopy approach can minimize the specimen and/or microscope acceleration/deceleration times during the relative movement. This can enable the scanning microscopy approach to eliminate settling and stop times between consecutive image acquisitions during a specimen inspection process.

The image intensity in RDF modality can be directly proportional to the RDF light illuminance of the microscope FOV and the sensitivity of the imaging system. In some embodiments, objects with sizes down to D=1 μm may produce RDF images with intensities having pronounced signal-to-noise (SNR) ratios with respect to the image background intensity.

Other “360° all around” RDF illuminators may generate a maximum of Pₒₚₜ=100-200 mW of optical power on their output. This level of optical power may be sufficient for reliable RDF imaging with area-scan cameras, working in still mode (i.e., the specimen and microscope do not move relative to each other during image acquisition) with unrestricted camera exposure time. This level of optical power may also be sufficient for reliable RDF imaging with line-scan cameras, having time delayed integration (TDI) capability, working in scanning mode at low line rates/low scanning speeds.

However, an optical power Pₒₚₜ=100-200 mW may not be sufficient for scanning RDF imaging applications with area-scan cameras. This level of optical power may also not be sufficient for scanning RDF applications with line-scan cameras, having TDI capability, working at moderate to high line rates/moderate to high scanning speeds.

Scanning RDF imaging may be achieved using an area-scan imaging system working in conjunction with a strobe light RDF illuminator. The illuminator must provide light pulses with sufficiently high intensity to enable acquisition of microscope images with sufficient brightness. Additionally, the light pulses should be sufficiently short, to avoid pronounced scanned image smearing.

Scanning microscopy applications may typically use low magnification BD objective lenses, for example, magnifications/numerical apertures (NA) may be 1×/0.025, 2×/0.055, 5×/0.14, 7.5×/0.21 and 10×/0.28. For low magnification objective lenses and tube lens with a 1× magnification, monochrome cameras with pixel sizes of 3.5-5 μm or smaller may be used for suitable imaging of objects in blue light (wavelength λ˜450 nm). As an example, a global shutter monochrome area-scan camera may have pixel size of p=4.5 μm, an image acquisition frame rate of 207 fps, and a pixel row count of ˜2200. To obtain images that are not smeared more than one pixel in scanning mode operation, the RDF illuminator may need to generate light pulses with duration T=2.2 usec or shorter. RDF illuminators, generating optical power Pₒₚₜ˜12-15 W in pulsed emission mode with pulse duration down to T=2.2 μs, may be suitable for reliable scanning RDF imaging with monochrome area-scan cameras, working at maximum frame rates.

High speed scanning RDF imaging may be achieved using imaging system with line-scan camera, having TDI capability, and working in conjunction with high constant power RDF illuminator. RDF illuminators, generating optical power Pₒₚₜ˜4-6 W in constant emission mode, may be suitable for reliable scanning RDF imaging with line-scan cameras, having TDI capability, and working at maximum line rates/maximum scanning speeds.

The above-described estimates assume that area-scan cameras and line-scan cameras gain was set at nominal values, and the cameras pixels binning was disabled.

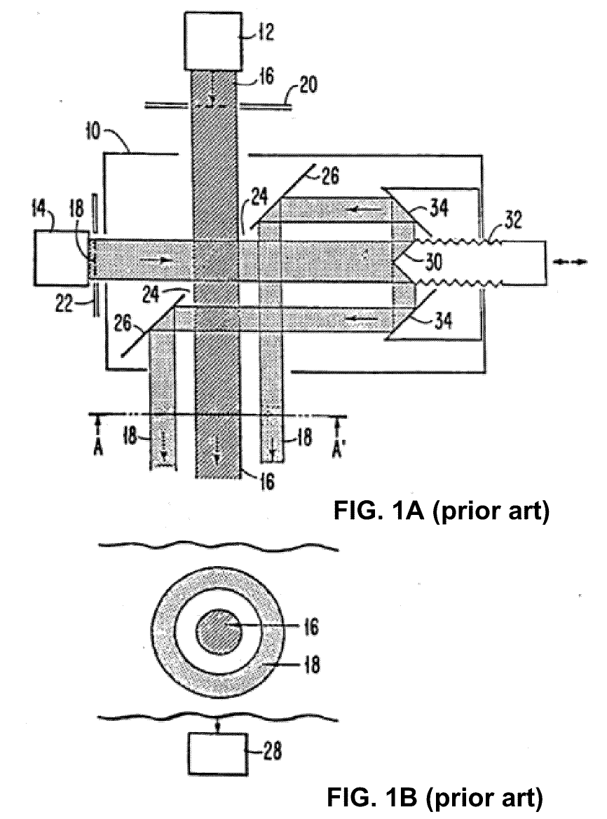

Reference is now made to FIGS. 1A and 1B. FIG. 1A shows a schematic view of a microscope RBF illuminator 10 described in U.S. Pat. No. 4,585,315 and FIG. 1B shows a cross-sectional view of the illumination pattern along the line A-A′. The illuminator 10 includes a light source 14, first axicon mirror 30, second axicon mirror 34, flat first surface mirror 26 with optically transparent opening 24 in its center and BD objective 28.

The light source 14 generates collimated beam of light 11. Beam of light 11 passes through opening 24 in the mirror 26 towards first axicon mirror 30. The first axicon mirror 30 and the second axicon mirror 34 convert collimated beam of light 11 into hollow cylinder of light 18. The cylinder of light is reflected towards BD objective 28 with mirror-coated portion of the mirror 26. The cylinder of light 18 passes towards BD objective 28 through opening 13 in the illuminator 10. The light hollow cylinder cross-section is shown at section A-A′. BD objective 28 collects light, scattered from a specimen, and directs it to the microscope imaging system through openings 13 and 12 in the illuminator 10.

Powerful RDF illuminators with axicon optics may be used for research applications where the microscope may only be required to operate in the RDF modality. However, powerful RDF illuminators with axicon optics may not be suitable for commercial/industrial applications because the microscope may be required to support multiple optical modalities in such applications. Additional optical elements, besides mirror 26, may be required to be placed into the microscope infinity space to facilitate the other optical modalities. Infinity space refers to a space along the microscope optical axis between the microscope objective and the microscope tube lens. Reflective bright field (RBF) illumination coupling beamsplitters, polarizers, prisms for differential interference contrast are examples of elements, placed into conventional microscope infinity space. Industrial microscopes may additionally have autofocus sensor coupling filters and technological laser coupling filters in their infinity space.

If the above-noted additional elements are placed into the microscope infinity space between illuminator 10 and objective 28, they may interfere with the hollow cylinder of light. To avoid this interference, the illuminator 10 may be placed above objective 28, such that no other optical elements reside between the illuminator 10 and the objective 28.

Commercially available BD objectives may have RDF ports outside diameters up to O.D.=37 mm. Accordingly, the mirror 26 must provide clear aperture CA>37 mm for light cylinder 18 at angle of incidence AOI=45°. As a result, illuminator 10 must have height H˜40 mm or more. However, placing a tall element into the microscope infinity space can require increasing the clear apertures of the other optical elements. The microscope body may need to be expanded to accommodate optical elements with increased clear apertures and their holders. As the infinity space increases, the clear apertures of the optical elements within the infinity space may need to be increased to preserve the same image size for the imaging system. Such modifications can increase the production cost and complexity of the microscope.

Accordingly, for the RDF illuminator to be used as an optional microscope component, it should have a small height and it should be positioned above the microscope objective such that no other optical elements reside between the RDF illuminator and the microscope objective.

Examples of commercially available RDF illuminators with height H=13 mm and H=22 mm are described in U.S. Patent Publication No. 2014/0126049 A1 and U.S. Patent Publication No. 2021/0302711 A1. These illuminators use light emitting diodes (LEDs) as light sources. The optical power on their output does not exceed Pₒₚₜ=120 mW.

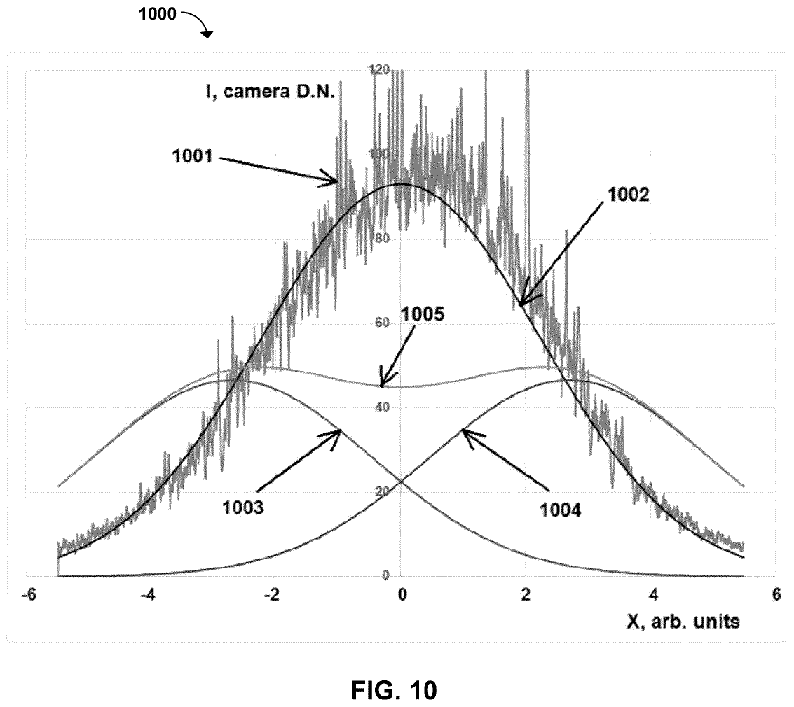

Another example RDF illuminator with 15 single mode laser diodes (LDs) is shown at FIG. 10 in U.S. Patent Publication No. 2021/0302711 A1. The optical power on the illuminator output Pₒₚₜ=1.5 W. As described above, this optical power level may be sufficient for reliable RDF imaging with TDI line-scan cameras, working in scanning mode at low to moderate line rates/low to moderate scanning speeds. However, this optical power level may not be sufficient for scanning RDF imaging applications with area-scan cameras and for scanning RDF applications with TDI line-scan cameras, working at high line rates/high scanning speeds.

The optical power level may be increased using more powerful multi-mode LDs, driven with low driving currents. However, this can significantly increase the production cost. Additionally, powerful multi-mode LDs cannot be run at their nominal-to-high driving currents, being installed into the RDF illuminator as per U.S. Patent Publication No. 2021/0302711 A1, due to heat transfer limitations.

Another problem with implementation of LDs in RDF illuminators, as per U.S. Patent Publication No. 2021/0302711 A1 is that powerful surface-mounted LDs may not be commercially available. Furthermore, the LDs must be placed into the illuminator and aligned individually. The individual alignment of multiple LDs can increase the cost and complexity of producing the RDF illuminators.

Therefore, as explained herein above, there is a need for high optical power RDF illuminators having a small height and a small/flexible number of light sources.

The disclosed systems and methods can generate sufficiently high-power RDF illumination for a microscope to meet the above-described requirements for scanning RDF imaging applications with area-scan cameras and for scanning RDF applications with TDI line-scan cameras, working at high line rates/high scanning speeds.

The disclosed systems and method can provide a compact design and height reductions for the RDF illuminator components to improve support for multiple optical modalities to be implemented using the same microscope.

The disclosed systems and methods can provide light sources positioned remotely from the microscope to solve heat transfer and/or heat dissipation problems associated with other light sources where heat generated by the light sources may affect other microscope components.

The disclosed systems and methods can enable a reduction in the total number of light sources required for creating “360° all around” RDF illumination. This can enable a reduction in size, cost, and/or manufacturing complexity.

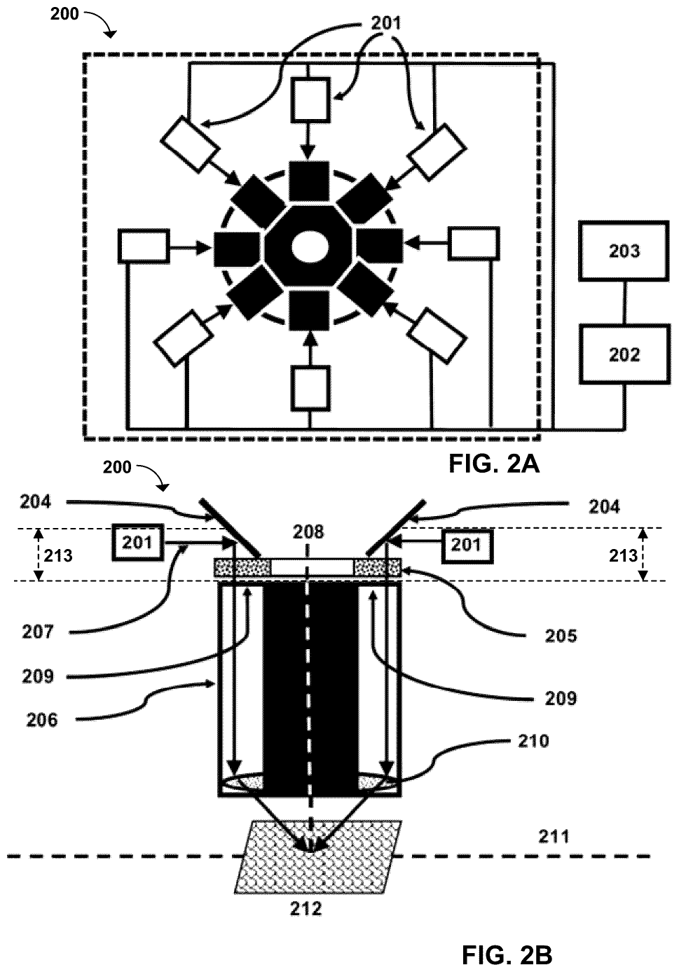

Reference is now made to FIGS. 2A and 2B, showing a top-view schematic and a side-view schematic respectively of an apparatus 200 for generating RDF illumination for a microscope, in accordance with an embodiment. Apparatus 200 includes multiple RDF illumination light sources 201 and multiple beam directing assemblies 204.

Light sources 201 may be positioned to emit light beams 207 that are substantially orthogonal to a microscope optical axis 208. Light beams 207, emerging from light sources 201 may be collimated or substantially collimated.

Apparatus 200 may include any suitable number of light sources 201. For example, apparatus 200 may include one to eight light sources 201. In the illustrated example, apparatus 200 includes eight light sources 201. A smaller number of light sources 201 may reduce the cost and complexity of apparatus 200. In some examples, apparatus 200 may include greater than eight light sources 201 (e.g., 8-12). A greater number of light sources 201 may provide higher illuminance.

Apparatus 200 may further include a light sources driver 202 and a control system 203. Control system 203 may send commands to light sources driver 202 to control power output of light sources 201. Light sources 201 may be powered up to emit light in a constant emission mode or in a pulsed emission mode. In some embodiments, light sources 201 may be powered up simultaneously, or in groups, or individually, according to the commands from control system 203 sent to the light sources driver 202.

Apparatus 200 may include any suitable number of beam directing assemblies 204. In the illustrated example, each beam directing assembly 204 is associated with a corresponding light source 201 and apparatus 200 may include a total of eight beam directing assemblies 204.

Beam directing assemblies 204 may be positioned at substantially identical optical axis distances 213 from an RDF port 209 of a microscope BD objective 206. Beam directing assemblies 204 may include any suitable optical components. In the illustrated example, beam directing assemblies 204 includes fold mirrors 204. Fold mirrors 204 may be positioned obliquely to the microscope optical axis 208 at any suitable angle to reflect the light from light sources 201 into RDF port 209. In the illustrated example, fold mirrors 204 are positioned above RDF port 209 in a ring configuration at approximately 45° angles with respect to the microscope optical axis 208. Light beams 207 from light sources 201 can fall on fold mirrors 204 under angle of incidence AOI=45°. Fold mirrors 204 can redirect the light from light sources 201 into RDF port 209 to form a hollow light cylinder around the microscope optical axis 208.

An internal light diverting element 210 may be positioned within microscope BD objective 206. Internal light diverting element 210 may divert the hollow light cylinder towards the microscope FOV to create oblique “360° all around” RDF illumination in a microscope object plane 211, where specimen 212 may be placed.

In some embodiments, the internal light diverting elements 210 may be designed to create an image of the RDF illuminator light emitting area in the microscope FOV. In some examples, the corresponding RDF illuminator light emitting area images in the microscope object plane 211 may be large in comparison with a required microscope FOV, for example, when the RDF illuminator light emitting area is a large diameter optical fiber bundle edge, or a large diffuser area, or a large emitter size LED.

To enlarge RDF illumination area in the microscope object plane 211, some microscope BD objectives 206 may have additional light dispersing elements (diffusers, lens arrays) positioned inside their RDF ports.

Laser diodes may have relatively small light emitting areas. For example, the emitter size for a multi-mode LD may be of the order 40×1 μm. Accordingly, the area of the corresponding images, created by the internal light diverting element 210 in the microscope object plane 211 may be small in comparison with the required FOV. Additional light dispersing elements positioned within microscope BD objectives 206 may not be sufficient to expand the area of the corresponding images up to the required FOV. In some embodiments, a diffuser 205 may be positioned between beam directing assemblies 204 and RDF port 209 to improve the object plane RDF illuminance distribution.

Any suitable device may be used as light sources 201. In some embodiments, light sources 201 may generate collimated beams of light enabling the light sources 201 to be positioned farther away from microscope BD objective 206 to prevent heat generated by light sources 201 from affecting the other microscope components. This can address heat transfer problems associated with other RDF illuminators where the light sources are positioned closer to the other microscope components. To create collimated beams, propagating at large distances with minimal losses, light sources 201 with small light emitting areas may be used. In some embodiments, light sources 201 may be preferably implemented as semiconductor LDs. In other embodiments, other devices may be used for implementing light sources 201, for example, light emitting diodes.

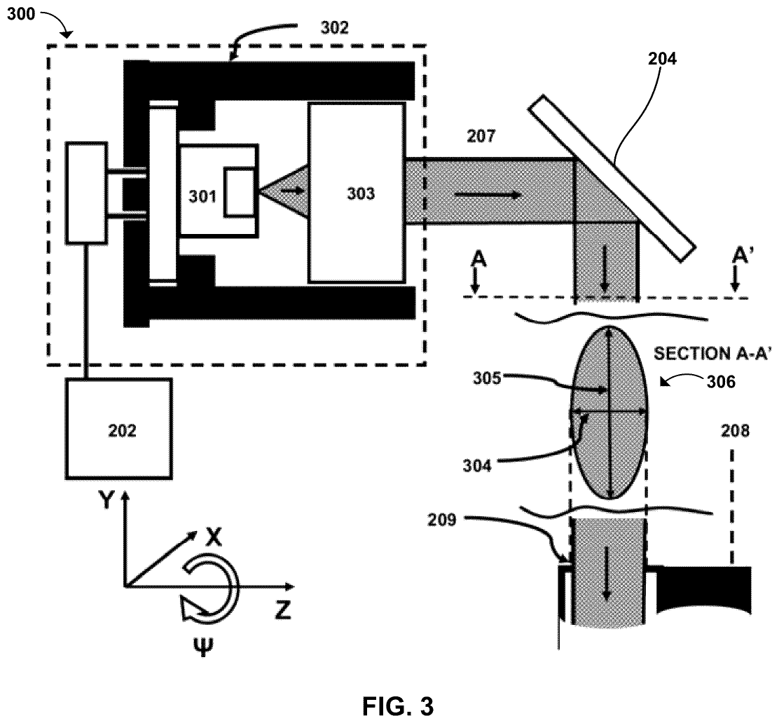

Apparatus 200 may include different types of light sources 201 including, for example, integrated and remote light sources. Concurrent reference is now made to FIGS. 2 and 3. FIG. 3 shows a schematic diagram of an integrated light source 300, in accordance with an embodiment. Integrated light source 300 may be attached to a microscope and used, for example, as one or more of RDF illumination light sources 201.

Integrated light source 300 may include a LD 301 and a collimating lens assembly 303 positioned between LD 301 and a corresponding beam directing assembly 204. Integrated light source 300 may be connected to light sources driver 202 to supply power to LD 301.

LD 301 may be mounted inside a holder 302. Holder 302 may facilitate emitter roll angle ψ axial alignment of LD 301. Holder 302 may further facilitate roll angle ψ axial alignment and lateral alignment in X, Y and Z directions of collimating lens assembly 303.

LD 301 may be any suitable laser diode. LD 301 may emit light in the visible wavelength range to provide better performance in combination with commercially available BD objectives that are designed for visible range of wavelengths: 400-700 nm. Further, LD 301 light emission in visible wavelength range may provide better performance with area-scan and line-scan cameras that have pronounced sensitivity in the visible wavelength range. Within the visible wavelength range, shorter wavelength range RDF illumination light emission may provide higher performance because the optical resolving power of microscope BD objective 206 may be better for shorter wavelengths. In some embodiments, LD 301 may be a short visible wavelength, multi-mode, high-power semiconductor laser diode. Objects with sizes much smaller than the illumination light wavelength may be qualified as Rayleigh scatters. Shorter wavelength LD 301 light emission may improve small objects (Rayleigh scatters) detection, wherein the scattered light intensity for these objects is proportional to 1/λ⁴, where Δ is the light wavelength.

Collimating lens assembly 303 may have any suitable design. In some embodiments, collimating lens assembly 303 may be anamorphic. Collimating lens assembly 303 may include spherical/aspheric and/or cylindrical/acylindrical lenses. In some embodiments, all the lenses of collimating lens assembly 303 may have antireflective coatings. The antireflective coatings may be tailored to the emission wavelength λ of LD 301.

The output light beam 207 from collimating lens assembly 303 may be collimated or substantially collimated. Portion 306 of FIG. 3 shows a cross-section along line A-A′ of light beam 207 redirected by beam directing assembly 204. The redirected light beam may have an elliptical cross-sectional shape. The ellipse height 304 may be substantially equal to the width of RDF port 209. In examples that include diffuser 205, the ellipse height 304 may be reduced to avoid excessive light losses inside the RDF port. The ellipse width 305 may be substantially equal to the width of beam directing assembly 204, for example, the width of fold mirror 204. In some embodiments, the light intensity distribution along both ellipse axes may be Gaussian.

Holder 302 of LD 301 and collimating lens assembly 303 may be positioned relative to each other such that emerging light beam 207 propagates orthogonally to the microscope optical axis 208.

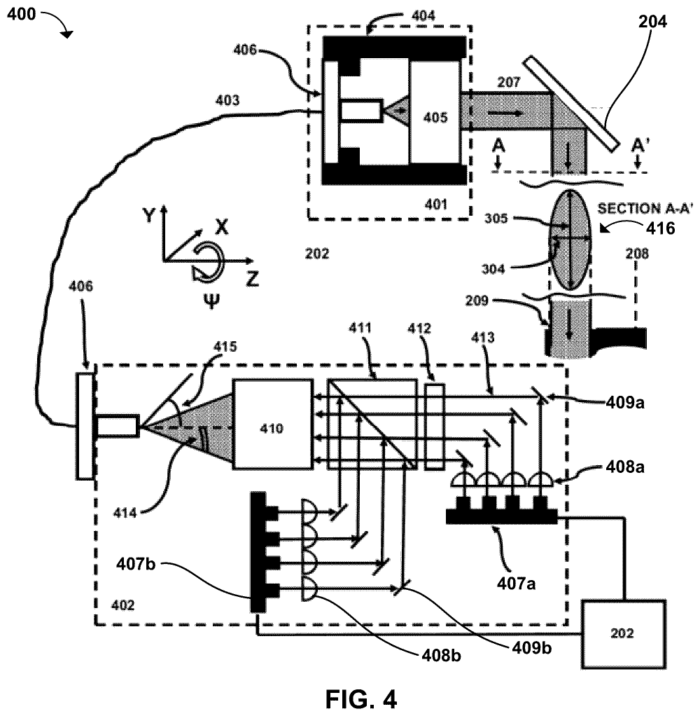

Concurrent reference is now made to FIGS. 2 and 4. FIG. 4 shows a schematic diagram of a remote light source 400, in accordance with an embodiment. Remote light source 400 may be used, for example, as one or more of RDF illumination light sources 201.

Remote light source 400 may include an optical head compartment 401 attached to a microscope, and a light engine compartment 402 positioned remotely from the microscope.

Optical head compartment 401 may be optically coupled to light engine compartment 402 using any suitable mechanism. In the illustrated example, optical head compartment 401 is optically coupled to light engine compartment 402 using an optical fiber 403. In some embodiments, optical fiber 403 may include a single core optical fiber. In some embodiments, an industrial-grade optical fiber may be used if remote light source 400 is designed to emit high intensity light while operating in a constant emission mode. The core diameter and numerical aperture (NA) of the optical fiber may be selected to optimize the balance between light energy injection into the fiber and the fiber core diameter reduction. As one example, the industrial-grade single core optical fiber may have the following parameters: core diameter D=100-200 μm, NA=0.12-0.2. In other examples, optical fiber 403 may have different parameters.

Optical head compartment 401 may include a holder 404 and a collimating lens assembly 405. Collimating lens assembly 405 may be positioned between the optical head compartment 401 and a corresponding beam directing assembly 204. Holder 404 may facilitate the attachment of connector 406 of optical fiber 403 to optical head compartment 401. Holder 404 may further facilitate the roll angle Y axial alignment and the lateral alignment in X, Y and Z directions of collimating lens assembly 405.

Light engine compartment 402 may include one or more arrays of LDs 407, one or more arrays of collimating lenses 408, one or more arrays of fold mirrors 409 and a light focusing assembly 410.

Each array of LDs 407 may include one or more LDs. In some embodiments, the LDs may be short visible wavelength, multi-mode, high-power semiconductor laser diodes. In other embodiments, the LDs may be any other suitable type of laser diodes. The arrays of LDs 407 may be driven by light sources driver 202.

Light engine compartment 402 may include any suitable number of arrays of LDs 407 (e.g., 1 to 4). A larger number of arrays and/or larger number of LDs per array may enable light engine compartment 402 to generate higher light output levels. A smaller number of arrays and/or smaller number of LDs per array may reduce the cost/complexity of light source 400. In the example illustrated in FIG. 4, light engine compartment 402 includes two arrays of LDs (407a, 407b), two arrays of collimating lenses (408a, 408b) and two arrays of fold mirrors (409a, 409b).

Any suitable configuration may be used for each array of LDs 407. In some embodiments, commercially available arrays of multi-mode visible light LDs having attached compound aspheric lenses may be used for implementing one or more of the arrays of LDs 407. As one example configuration, each array of LDs may contain from 20 to 28 LDs, arranged in 5×4 to 7×4 LD matrices. The LDs may be driven with nominal constant currents and emit up to approximately 160 W optical power (Pₒₚₜ). Other embodiments may use a different configuration.

In another example embodiment, light engine compartment 402 may include a single array of LDs (e.g., 407a), a single array of collimating lenses (e.g., 408a) and a single array of fold mirrors (e.g., 409a). The array of collimating lenses 408a may be positioned to collimate light emitted by the array of LDs 407a. The array of fold mirrors 409a may be positioned to redirect light output from the array of collimating lenses 408a towards the light focusing assembly 410. Arrays of fold mirrors 409 may be maiden of dielectric mirrors to reduce light losses and prevent overheating of light engine compartment 402. The light focusing assembly 410 may be positioned to focus light output from the array of fold mirrors 409a into the core aperture of optical fiber 403.

In some embodiments, light engine compartment 402 may further include a polarizing beamsplitter 411. For the embodiment illustrated in FIG. 4, polarizing beamsplitter 411 may be used to combine light output originating from two arrays of LDs 407a and 407b. The light output from the arrays of LDs 407 may be substantially polarized. For example, the arrays of LDs 407 may include multi-mode semiconductor laser diodes that emit substantially polarized light with polarization ratio of approximately 100:1.

Polarizing beamsplitter 411 may be configured to transmit substantially all the light (with minimal losses) from first array of fold mirrors 409a. Polarizing beamsplitter 411 may be further configured to reflect substantially all the light (with minimal losses) from second array of fold mirrors 409b.

As a first example, the light from first array of fold mirrors 409a may be substantially −s polarized and the light from second array of fold mirrors 409b may be substantially orthogonally polarized, i.e., −p polarized. Polarizing beamsplitter 411 may be configured to transmit substantially all the −s polarized light from first array of fold mirrors 409a towards light focusing assembly 410. Polarizing beamsplitter 411 may be further configured to reflect substantially all the −p polarized light from second array of fold mirrors 409b towards light focusing assembly 410.

As a second example, the light from first array of fold mirrors 409a may be substantially −p polarized and the light from second array of fold mirrors 409b may be substantially orthogonally polarized, i.e., −s polarized. Polarizing beamsplitter 411 may be configured to transmit substantially all the −p polarized light from first array of fold mirrors 409a towards light focusing assembly 410. Polarizing beamsplitter 411 may be further configured to reflect substantially all the −s polarized light from second array of fold mirrors 409b towards light focusing assembly 410.

Any suitable design may be used for implementing polarizing beamsplitter 411. In some embodiments, polarizing beamsplitter 411 may be a Glan-Thompson prism, a Glan-Foucault prism, a dielectric film plate polarizer, a polarizing beamsplitting (PBS) cube, or a wire-grid plate polarizer. In the illustrated embodiment, a PBS cube is used as polarizing beamsplitter 411. In other embodiments, a different design may be used.

An efficiency E_{P} of polarizing beamsplitter 411 may be defined as a product of reflection coefficient R_{S} for −s polarized light and transmission coefficient T_{P} for −p polarized light according to equation (1) below—

$${E}_{P} = {R}_{S} * {T}_{P} \qquad Equation ( 1 )$$

The efficiency E_{P} of a PBS cube and dielectric film plate polarizer may be greater than the efficiency E_{P} of a wire-grid plate polarizer. For example, E_{P} may be approx. 0.9 for a wire-grid plate polarizer, E_{P} may be approx. 0.93-0.97 for a PBS cube and E_{P} may be close to 1.0 for a dielectric film plate polarizer. In other examples, polarizing beamsplitter 411 may have different efficiency values.

Light focusing assembly 410 may include any suitable combination of spherical/aspheric and/or cylindrical/acylindrical lenses. Light focusing assembly 410 can focus incident light beams (e.g., light from polarizing beamsplitter 411 (if present) or light beams 413 from first array of fold mirrors 409a) into a core aperture of optical fiber 403 such that the cumulative focused beam diameter is smaller than the optical fiber core diameter and the beam divergence angle 414 is smaller than the numerical aperture (NA) 415 of optical fiber 403. In some embodiments, all lenses of light focusing assembly 410 may have antireflective coatings that are tailored to emission wavelength A of the arrays of LDs 407.

In some embodiments, light focusing assembly 410 may be anamorphic. Multi-mode LDs may typically have substantially different light emission angles along their slow and fast axes. The anamorphic design of light focusing assembly 410 can increase light injection efficiency into the core of optical fiber 403.

In embodiments including an anamorphic design of light focusing assembly 410, the arrays of LDs 407a and 407b should have the same orientation. In such cases, light from arrays of fold mirrors 409a and 409b should have identical polarization for both arrays of LDs 407a and 407b. In such embodiments, light engine compartment 402 may further include a retardation plate 412 to enable combination of the light output originating from arrays of LDs 407a and 407b using polarizing beamsplitter 411. As illustrated in FIG. 4, retardation plate 412 may be positioned between first array of fold mirrors 409a and polarizing beamsplitter 411. Retardation plate 412 can rotate the polarization plane of incident light by 90°, i.e., retardation plate 412 can convert incident −p polarized light into −s polarized light and incident −s polarized light into −p polarized light.

As a first example, the light from both arrays of fold mirrors 409a and 409b may be substantially −s polarized. Retardation plate 412 can convert incident −s polarized light from first array of fold mirrors 409a into −p polarized light. Polarizing beamsplitter 411 may be configured to transmit substantially all the −p polarized light from retardation plate 412 towards light focusing assembly 410. Polarizing beamsplitter 411 may be further configured to reflect substantially all the −s polarized light from second array of fold mirrors 409b towards light focusing assembly 410.

As a second example, the light from both arrays of fold mirrors 409a and 409b may be substantially −p polarized. Retardation plate 412 can convert incident −p polarized light from first array of fold mirrors 409a into −s polarized light. Polarizing beamsplitter 411 may be configured to transmit substantially all the −s polarized light from retardation plate 412 towards light focusing assembly 410. Polarizing beamsplitter 411 may be further configured to reflect substantially all the −p polarized light from second array of fold mirrors 409b towards light focusing assembly 410.

Retardation plate 412 may be referred to as a half-wave plate (HWP) that converts incoming −s polarized light into −p polarized light (or vice-versa).

Light from light engine compartment 402 may be delivered to optical head compartment 401 via optical fiber 403. Light may emerge from the fiber end, having divergence equal to the optical fiber NA. Collimating lenses assembly 405 may collect and collimate this light.

Collimating lens assembly 405 may have any suitable design. In some embodiments, collimating lens assembly 405 may be anamorphic. Collimating lens assembly 405 may include spherical/aspheric and/or cylindrical/acylindrical lenses. In some embodiments, all the lenses of collimating lens assembly 405 may have antireflective coatings. The antireflective coatings may be tailored to the emission wavelength λ of arrays of LDs 407.

The output light beam 207 from collimating lens assembly 405 may be collimated or substantially collimated. Portion 416 of FIG. 4 shows a cross-section along line A-A′ of light beam 207 redirected by beam directing assembly 204. The redirected light beam may have an elliptical cross-sectional shape. The ellipse height 304 may be substantially equal to the width of RDF port 209. In examples that include diffuser 205, the ellipse height 304 may be reduced to avoid excessive light losses inside the RDF port. The ellipse width 305 may be substantially equal to the width of beam directing assembly 204, for example, the width of fold mirror 204. In some embodiments, the light intensity distribution along both ellipse axes may be Gaussian.

Connector 406 (of optical fiber 403) and collimating lens assembly 405 may be positioned relative to each other such that emerging light beam 207 propagates orthogonally to the microscope optical axis 208.

Remote light source 400 that includes a light engine compartment 402 positioned remotely from the microscope may provide a solution to heat transfer and/or heat dissipation problems associated with other light sources where heat generated by the light sources may affect other microscope components.

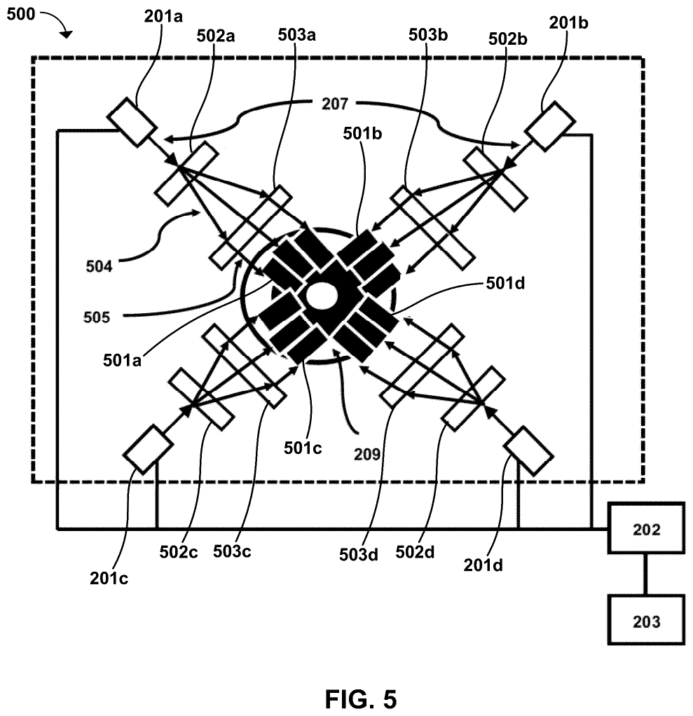

Reference is now made to FIGS. 2 and 5. FIG. 5 is a top-view schematic diagram of an apparatus 500 for generating high power RDF illumination for a microscope, in accordance with one or more embodiments. Based on the number and/or design of light sources 201 used in apparatus 200, multiple LDs alignment may be required for operation of apparatus 200. At a cost of emitted light intensity reduction compared with apparatus 200, apparatus 500 may enable a reduction in the multiple LDs alignment requirement and an illuminator size reduction in X and Y directions orthogonal to the microscope optical axis 208.

Apparatus 500 may include any suitable number of light sources 201 and multiple beam directing assemblies 501. For example, apparatus 500 may include two to six light sources 201. In the illustrated example, apparatus 500 includes four light sources 201a, 201b, 201c and 201d. A smaller number of light sources 201 may reduce the cost and complexity of apparatus 500. In some examples, apparatus 500 may include greater than six light sources 201 (e.g., 6-10). A greater number of light sources 201 may provide higher illuminance.

The number of beam directing assemblies 501 may correspond to the number of light sources 201. For example, output light beam 207 from each light source 201 (e.g., light source 201a) may be optically coupled to a corresponding beam directing assembly 501 (e.g., beam directing assembly 501a).

Any suitable design may be used for implementing beam directing assemblies 501. For example, each beam directing assembly 501 may include a group of fold mirrors. The group of fold mirrors may include multiple fold mirrors positioned obliquely to the microscope optical axis 208 to reflect incident light from a corresponding RDF illumination light source into RDF port 209.

A Gaussian light intensity distribution in a horizontal direction (normal to microscope optical axis 208) may not be optimal for apparatus 500. Centrally positioned mirrors within a group of fold mirrors may receive and reflect a greater amount of light into RDF port 209 compared with peripherally positioned mirrors. This can generate a substantially non-uniform “360° all around” illumination in the microscope FOV. In some embodiments, light intensity equalizers may be used to equalize the light intensity distribution (of light received from light sources 201) in the horizontal direction.

Apparatus 500 may include multiple light intensity equalizers 502. In the illustrated embodiment, apparatus 500 includes a light intensity equalizer 502 positioned between each RDF illumination light source 201 and corresponding beam directing assembly 501. For example, light intensity equalizers 502a-502d are positioned between RDF illumination light sources 201a-201d and corresponding beam directing assemblies 501a-501d respectively.

Any suitable design may be used for implementing light intensity equalizers 502. Refractive or diffractive optical elements may be used as light intensity equalizers 502. In some embodiments, a Powell lens may be used for implementing a refractive light intensity equalizer 502.

Collimated or almost collimated light beam 207, from light source 201 may be converted by light intensity equalizer 502 into light beam 504 that is diverging in the horizontal direction. The light intensity distribution along the diverging beam may have a pre-defined profile. In some embodiments, the light intensity distribution along the diverging beam may have a constant profile. Light beam 504 may remain collimated or almost collimated with a Gaussian light intensity distribution in a vertical direction (parallel to microscope optical axis 208).

To improve optical performance when using light intensity equalizer 502, the collimating lens assemblies associated with the light sources (e.g. collimating lens assembly 303 (FIG. 3) of integrated light source 300 or collimating lens assembly 405 in remote light source 400) may be designed and aligned to create collimated or almost collimated light beams 207 with a width (e.g., ellipse width 305 shown in FIGS. 3 and 4) tailored to the design of light intensity equalizer 502. The beam height (e.g., ellipse height 304 shown in FIGS. 3 and 4) may be maintained the same as described herein above, substantially equal to width of RDF port 209.

In some embodiments, apparatus 500 may include multiple collimating lens assemblies 503 positioned between each light intensity equalizer 502 and corresponding beam directing assembly 501. For example, FIG. 5 shows collimating lens assemblies 503a-503d positioned between light intensity equalizers 502a-502d and corresponding beam directing assemblies 501a-501d respectively.

Each collimating lens assembly 503 may include multiple cylindrical/acylindrical lenses. Collimating lens assembly 503 may convert diverging light beam 504 from light intensity equalizer 502 into a collimated light beam 505. Light beam 505 may be substantially collimated in horizontal and vertical directions. Light beam 505 may be redirected by beam directing assembly 501 into RDF port 209.

As described herein above with reference to diffuser 205 of apparatus 200 (FIG. 2), in some embodiments, a diffuser may be positioned between beam directing assemblies 501 and RDF port 209 to improve the object plane RDF illuminance distribution.

Apparatus 500 can enable a reduction in total number of light sources 201 required for creating “360° all around” RDF illumination. For example, apparatus 500 can couple each light source 201 to a group of multiple fold mirrors. This may reduce a cost and/or manufacturing complexity of the RDF illuminator (balanced against a corresponding reduction in illuminator light intensity). Further, this may provide a benefit in microscope applications having tighter space constraints by enabling a size reduction of the RDF illuminator in X and/or Y directions.

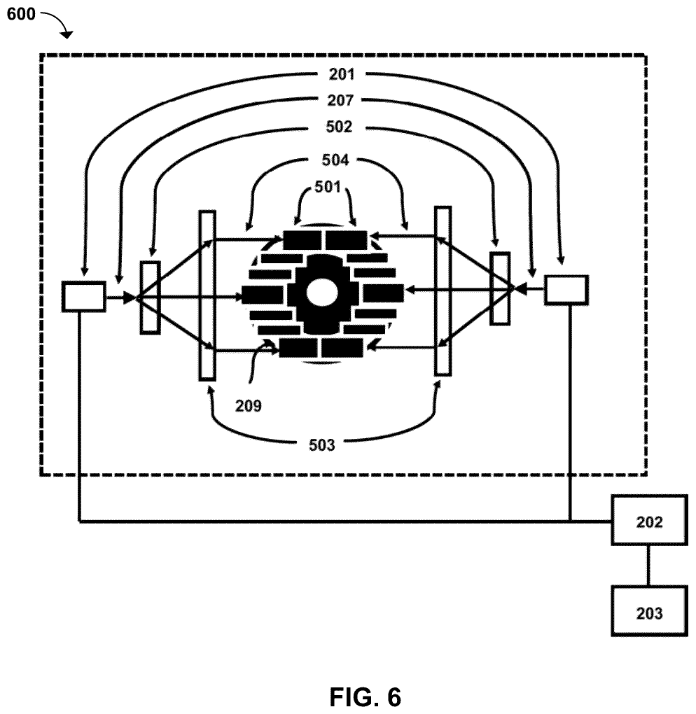

Reference is now made to FIGS. 5 and 6. FIG. 6 is a top-view schematic diagram of an apparatus 600 for generating RDF illumination for a microscope, in accordance with one or more embodiments. At a cost of emitted light intensity reduction compared with apparatus 500, apparatus 600 may enable a further reduction in the multiple LDs alignment requirement and an illuminator size reduction in X and Y directions orthogonal to the microscope optical axis 208.

Apparatus 600 may include just two light sources 201 and two beam directing assemblies 501. Any suitable design may be used for implementing beam directing assemblies 501. For the example embodiment illustrated in FIG. 6, beam directing assemblies 501 include multiple fold mirrors positioned obliquely to the microscope optical axis 208 to reflect incident light from corresponding RDF illumination light sources 201 into RDF port 209 to form “360° all around” illumination using just two light sources 201.

As described herein above with reference to apparatus 500, in some embodiments, apparatus 600 may further include light intensity equalizers 502 to equalize the light intensity distribution in a horizontal direction (normal to microscope optical axis 208). As shown in FIG. 6, apparatus 600 may include two light intensity equalizers 502. Each light intensity equalizer 502 may be positioned between an RDF illumination light source 201 and corresponding beam directing assembly 501.

Further, as described herein above with reference to apparatus 500, in some embodiments, apparatus 600 may further include collimating lens assemblies 503 to improve optical performance when using light intensity equalizers 502. As shown in FIG. 6, apparatus 600 may include two collimating lens assemblies 503. Each collimating lens assembly 503 may be positioned between a light intensity equalizer 502 and corresponding beam directing assembly 501.

As described herein above with reference to diffuser 205 of apparatus 200 (FIG. 2), in some embodiments, a diffuser may be positioned between beam directing assemblies 501 and RDF port 209 to improve the object plane RDF illuminance distribution.

In some embodiments, a further reduction in size and/or manufacturing complexity of the RDF illuminator may be achieved (at a cost of emitted light intensity reduction) by replacing half the fold mirrors of the beam directing assemblies with light beamsplitters and reducing the number of light sources by half.

For example, with reference to FIGS. 2A and 2B, if each beam directing assembly 204 is implemented as a fold mirror and apparatus 200 includes an even number of fold mirrors that all have the same size and are symmetrically positioned relative to microscope BD objective 206, then half the fold mirrors may be replaced with light beamsplitters and the total number of light sources 201 may be reduced by half.

As another example, with reference to FIG. 5, if each beam directing assembly 501 is implemented as a group of fold mirrors and apparatus 500 includes i) an even number of fold mirror groups, ii) all the fold mirror groups are symmetrically positioned relative to microscope BD objective 206, iii) each fold mirror group has the same number of fold mirrors, and iv) mirror size of each fold mirror in the fold mirror groups is identical, then half the fold mirrors may be replaced with light beamsplitters and the total number of light sources 201 may be reduced by half.

As another example, with reference to FIG. 6, if each beam directing assembly 501 is implemented as a group of fold mirrors and in apparatus 600 i) both fold mirror groups are symmetrically positioned relative to microscope BD objective 206, ii) both fold mirror groups have the same number of fold mirrors, and iii) mirror size of each fold mirror in the fold mirror groups is identical, then half the fold mirrors may be replaced with light beamsplitters and the total number of light sources 201 may be reduced by half.

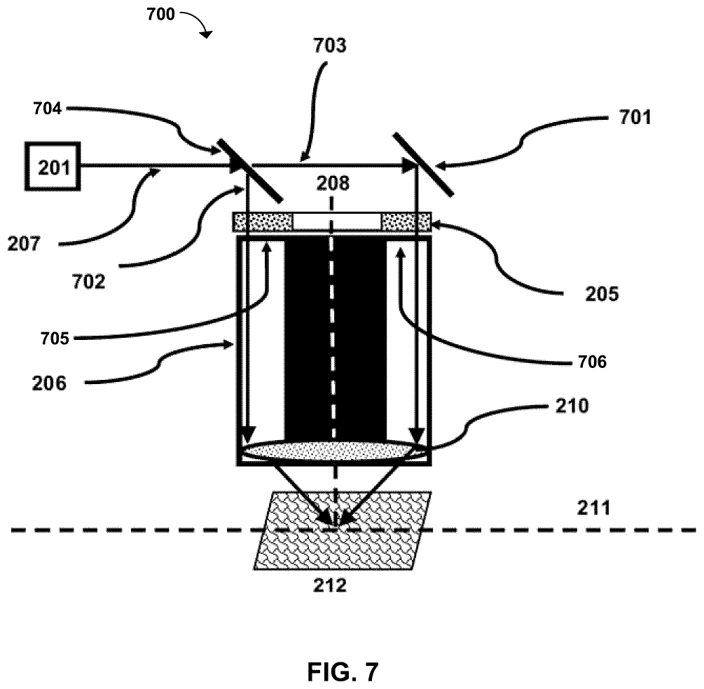

Reference is now made to FIG. 7. FIG. 7 is a side-view schematic diagram of an apparatus 700 for generating RDF illumination for a microscope, in accordance with one or more embodiments. Apparatus 700 illustrates an example where one of the fold mirrors 204 shown in FIG. 2B is replaced with a beamsplitter 704 and one of the two light sources 201 shown in FIG. 2B is excluded.

In apparatus 700, each beam directing assembly corresponding to a light source 201 may include one or more pairs of beam directing components. In the illustrated embodiment, the beam directing assembly includes a pair of beam directing components—beamsplitter 704 and a fold mirror 701.

Beamsplitter 704 may be positioned to split incident light beam 207 received from a corresponding RDF illumination light source 201 into a first light portion 702 directed into a first section 705 of the RDF port and a second light portion 703 substantially orthogonal to the microscope optical axis 208.

Beamsplitter 704 may be identically sized to replaced fold mirror 204. Beamsplitter 704 may be positioned in the same position and orientation as replaced fold mirror 204. Any suitable design may be used for implementing beamsplitter 704. In some embodiments, plate dielectric beamsplitters with light splitting ratio 50T/50R (50% of light is reflected, 50% of light is transmitted) may be used for implementing beamsplitter 704.

Fold mirror 701 may be identically sized as corresponding fold mirror 204 shown in FIG. 2. As shown in FIG. 7, fold mirror 701 may be positioned above RDF port 209 at approximately 45° angle with respect to the microscope optical axis 208. The second light portion 703 from beamsplitter 704 can fall on fold mirror 701 under angle of incidence AOI=45°. Fold mirror 701 may be positioned opposite to beamsplitter 704 to reflect the second light portion 703 from the beamsplitter into a second section 706 of the RDF port.

The configurations shown in FIGS. 5 and 6 can be similarly modified, as described above with reference to modifying the configuration shown in FIG. 2B to replace half the fold mirrors with beamsplitters and reduce the number of light sources by half.

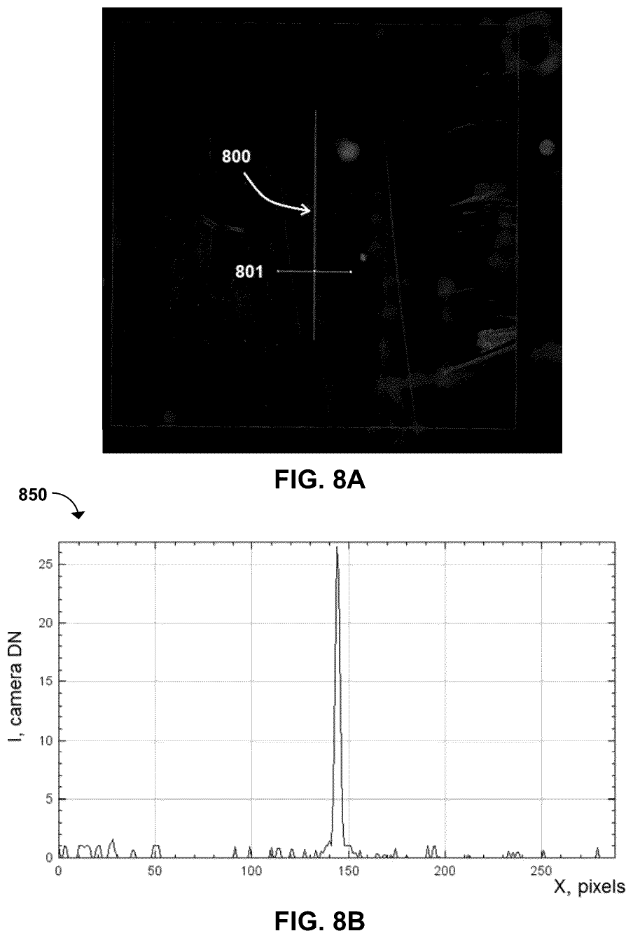

Reference is now made to FIG. 8A showing an RDF image of a chromium-on-glass strip 800, acquired using an example embodiment of the disclosed apparatus 600 including integrated light sources to generate the RDF illumination. Concurrent reference is made to components of the integrated light source and apparatus 600 shown in FIGS. 3 and 6 respectively.

Chromium strips of 2000×2×0.2 μm size were deposited on a soda-lime glass surface. The soda-lime glass specimen was placed at the center of the microscope FOV. The microscope was equipped with a BD objective lens having a 2× magnification and NA=0.055, and a tube lens having 1× magnification. The imaging system included a global shutter monochrome camera with pixel size p=3.45 μm. The camera image presentation data rate was set at 8 bits and the camera global amplification gain factor was set at nominal value G=1.0. Effective camera exposure time was set at Tₑₑ=5.0 μs. The camera pixels binning was disabled. The presented image intensity was amplified during post-processing for illustrative purposes.

Reference is now additionally made to FIG. 8B. FIG. 8B is a graph 850 showing unedited RDF image intensity distribution along line 801, drawn through the RDF image of the chromium-on-glass strip 800. For the RDF image intensity distribution illustrated in FIG. 8B, a SNR ˜25 was achieved for the image intensity peak corresponding to the chromium-on-glass strip with respect to the background.

Both integrated light sources of the RDF illuminator were equipped with high power multi-mode LDs. Both LDs emitted blue light with wavelength λ=450 nm. Light output from isomorphic collimating lens assembly 303 was substantially collimated and having an elliptical cross-section. The ellipse height was H ˜4 mm and the ellipse width was W ˜0.8 mm.

Powell lenses were used for implementing light intensity equalizer 502. Powell lenses and LDs were rotated relative to each other to create desired light intensity distribution along the diverging beam of light and reduce the beam height on the equalizer output down to H ˜3.5 mm, which matched the RDF port width of the microscope BD objective. Plastic acylindrical Fresnel lenses were used to collimate diverging light beams in horizontal direction.

Dielectric mirrors with reflectance coefficient R=99.99% at wavelength λ=450 nm were used to implement beam directing assemblies 501. The mirrors were arranged in two groups with each group having 11 mirrors (for a total number of 22 mirrors).

Diffuser 205 was implemented using an isotropic diffuser, with scattering angle characterized at full width at half maximum (FWHM)=2°, was positioned between the mirrors and the BD objective lens. The height of the RDF illuminator was H=21 mm.

Cumulative light intensity at the illuminator output was Pₒₚₜ=5 W in constant emission mode and Pₒₚₜ=13 W in pulsed emission mode.

The example image of FIG. 8A and image intensity graph 850 of FIG. 8B appear to indicate that the RDF illuminator in accordance with a disclosed embodiment i) can provide image acquisition with acceptable intensity for a typical specimen of industrial interest; ii) that the images can be acquired with global shutter area-scan monochrome cameras, having pixel size as small as p=3.5-5.0 μm at maximum camera framerates; and iii) can limit image smearing for the maximum cameras framerate to below one pixel. Images can also be acquired using line-scan cameras, having TDI capability and working at maximum of their line rates/maximum scanning speeds.

Some important practical applications may be focused on object/defect detection, rather than on their accurate RDF imaging. For such applications, camera pixels binning may be beneficial. Camera pixel binning may increase the RDF channel sensitivity and the object/defect image SNR with respect to the image background. Alternatively, further RDF channel sensitivity may be increased, while keeping the imaging SNR constant, by simultaneous pixels binding and specific camera gain increases. Said improvements may be achieved at the cost of a reduction in the RDF channel optical resolving power.

As the magnification of BD objectives decreases, the imaged FOV size increases. For example, if BD objective has a field number FN=24 and the microscope has a tube lens with magnification 1×, then the FOV size for BD objective with magnification 20× will be D=1.2 mm. For BD objective with magnification 2×, the FOV size expands up to D=12 mm.

Some low magnification BD objectives may not provide uniform RDF illumination for the entire FOV. Significant RDF illumination roll offs from the FOV center to FOV periphery may be observed. The RDF illumination roll off in a microscope object plane can cause significant RDF images intensity roll off, observed from the image center to the image periphery.

To improve the FOV coverage with RDF illumination, some BD objectives may include light dispersing elements (diffusers, lens arrays) inside their RDF ports. However, combined light dispersing performance of BD objective light dispersing element and the RDF illuminator internal diffuser may be insufficient to create RDF illuminance in the microscope FOV with desired light intensity distribution.

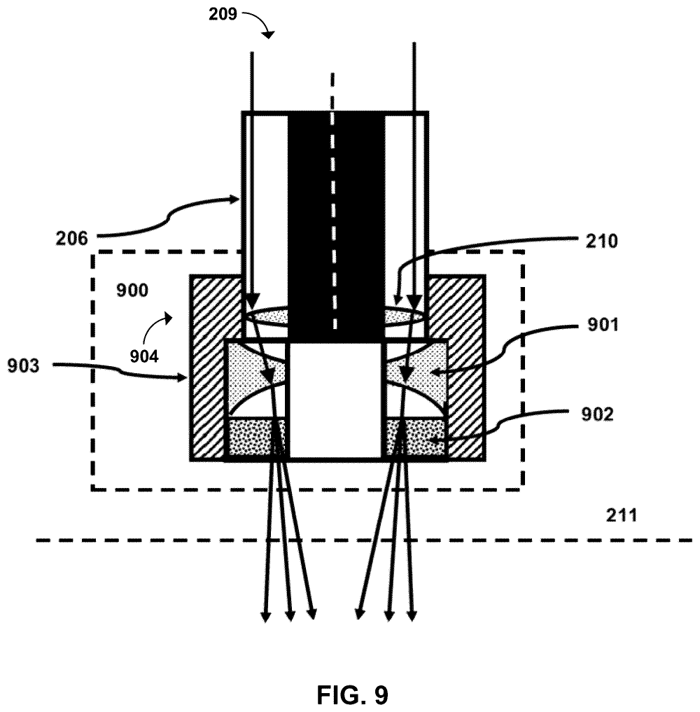

Reference is now made to FIGS. 2 and 9. FIG. 9 shows a side-view schematic diagram of an external light diverting element (ELDE) 900 attached to microscope BD objective 206 at an end 904 opposite to the RDF port 209. ELDE 900 may include a holder 903 and an ELDE lens 901.

Holder 903 may have any suitable design to enable other components of ELDE 900 to be attached to the microscope. ELDE lens 901 may be mounted inside holder 903. Holder 903 may be attached to microscope BD objective 206 such that ELDE lens 901 is positioned below ILDE 210.

ELDE lens 901 may introduce additional optical power into the RDF illumination light propagation optical path. As a result, the RDF illumination light may be focused at an offset (above or below) microscope object plane 211. If the RDF illumination light is focused above microscope object plane 211, it further diverges, and the illuminated area in the microscope object plane 211 increases. If the RDF illumination light is focused below the microscope object plane 211, the light in the object plane is not focused, and the illuminated area is larger compared with the case when the RDF illumination light is focused. Focusing the RDF illumination light below microscope object plane 211 may be beneficial when the average RDF illumination light angle of incidence onto the microscope object plane 211 decreases. For many objects of interest, calculated scattered light intensity, defined by bi-directional reflectance function (BDRF), increases in the microscope viewing direction when the RDF illumination light angle of incidence onto the microscope object plane decreases.

Reference is now additionally made to FIG. 10. FIG. 10 is a graph 1000 showing examples of acquired and theoretical RDF image intensity distributions for images acquired using an example embodiment of the apparatus for generating RDF illumination for a microscope.

Curve 1001 shows RDF image intensity distribution along a diagonal line in an RDF image of a holographic diffuser (scattering angle) FWHM=40° acquired using a 1″ monochrome camera and a low magnification BD objective. Curve 1001 shows a significant image intensity roll off from the center of the acquired RDF image towards the periphery of the acquired RDF image. Curve 1002 shows a Gaussian approximation of the acquired intensity distribution.

Curves 1003 and 1004 show theoretical image intensity distributions for the RDF image generated by left and right parts respectively of a defocused RDF beam. Curve 1005 shows a cumulative theoretical image intensity distribution of curves 1003 and 1004.

An ELDE 900 having ELDE lens 901 may be used to defocus the RDF beam. In this example, ELDE 900 does not include a diffuser. As a result, while the peaks have different magnitudes, the left and right intensity peaks shown by curves 1003 and 1004 respectively have the same shape as the peaks of curves 1001 and 1002.

Based on the law of energy conservation, a sum of the integrated areas under curves 1003 and 1004 (or the integrated area under cumulative theoretical image intensity distribution curve 1005) is equal to the integrated area under curve 1002. However, the magnitude of curve 1005 is lower compared with the corresponding magnitudes of curves 1001 and 1002, while the width of curve 1005 is larger compared with the width of the curves 1001 and 1002 (with corresponding area under the curves being equal). In this way, RDF image intensity roll off may be reduced at a cost of reduced image intensity using ELDE 900 having ELDE lens 901. For example, based on the energy conservation law, an RDF image intensity distribution peak broadening of 2× may be achieved at a cost of 2× reduction in the peak magnitude.

However, as the separation between curves 1003 and 1004 increases, a corresponding intensity dip in the center of the image also increases. In some cases, the image intensity distribution broadening achieved using ELDE 900 having ELDE lens 901 (but no diffuser) may not be sufficient. In some embodiments, ELDE 900 may further include a diffuser 902 to address this problem.

Diffuser 902 may be positioned to diffuse incident light from ELDE lens 901 towards the microscope FOV. Diffuser 902 may be mounted inside holder 903 such that diffuser 902 is positioned below ELDE lens 901.

Diffuser 902 can broaden the intensity distribution peaks of curves 1003, 1004 and 1005. The diffuser light scattering angle may be selected such that diffuser 902, in combination with ELDE lens 901, defocuses the RDF illumination light to achieve the maximum separation between peaks of curves 1003 and 1004 while maintaining the image intensity dip in the center of the image at an acceptable level. This can enable a target image intensity distribution broadening to be achieved.

Broadening image intensity distribution using an isotropic diffuser can introduce significant light losses. For example, an RDF image intensity distribution peak broadening of 2× using isotropic diffuser 902 may be achieved at a cost of a 4× reduction in the peak magnitude.

Any suitable design may be used for implementing ELDE lens 901 and diffuser 902. For example, spherical or cylindrical lenses may be used for implementing ELDE lens 901. Isotropic and anisotropic diffusers may be used for implementing diffuser 902. Spherical lenses and isotropic diffusers may be used to expand RDF image intensity distribution for area-scan cameras. Cylindrical lenses and anisotropic diffusers may be used to expand RDF image intensity distribution for line-scan cameras in the “along the chip” direction.

In some embodiments, a preferred implementation of ELDE 900 may exclude diffuser 902, unless the diffuser is required to achieve a target image intensity distribution broadening.

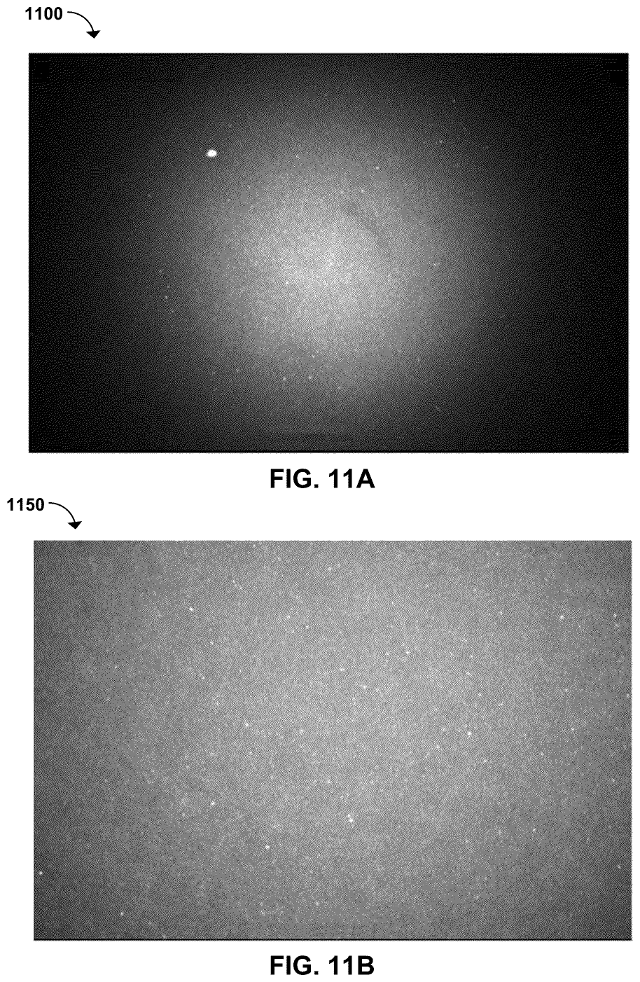

Reference is now made to FIGS. 9, 11A and 11B. FIG. 11A shows a RDF image 1100 of a holographic diffuser (scattering angle) FWHM=40° acquired with a microscope equipped with low magnification BD objective, tube lens having magnification 1× and 1″ monochrome camera (camera photosensitive chip diagonal d=16 mm). RDF image 1100 shows a significant image intensity roll off from the image center to the image periphery. FIG. 11B shows a RDF image 1150 of the same holographic diffuser specimen acquired with the same microscope and BD objective, but with an example embodiment of ELDE 900 attached to the BD objective during imaging. The example embodiment of ELDE 900 used during imaging included negative plastic Fresnel lens with focal distance f=−130 mm and an isotropic diffuser with scattering angle FWHM=5°.

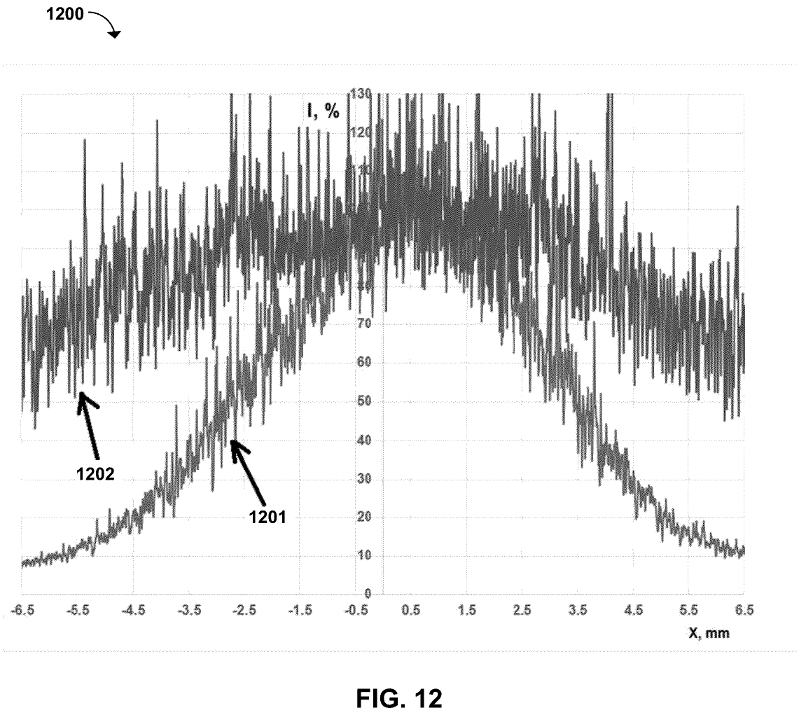

Reference is now additionally made to FIG. 12. FIG. 12 is a graph 1200 showing image intensity distributions in acquired RDF images 1100 and 1150 normalized to 100%. Curve 1201 shows image intensity distribution along a diagonal of RDF image 1100 normalized to 100%. Curve 1202 shows image intensity distribution along a diagonal of RDF image 1150 normalized to 100%. Curves 1201 and 1202 indicate that the RDF image intensity roll off may be reduced from ˜90% to ˜35% by using ELDE 900 during imaging. It may be noted that to obtain the same image intensity when using this example embodiment of ELDE 900, a 5.5× increase in the microscope RDF channel sensitivity may be required. This increase in the microscope RDF channel sensitivity may be achieved, for example, by increasing the RDF illuminator intensity and/or the camera exposure time.

Residual RDF image intensity roll off may be introduced by the microscope BD objective itself and/or the microscope tube lens (and not by the RDF illumination light intensity distribution in the microscope object plane). The example RDF images 1100 (FIG. 11A) and 1150 (FIG. 11B) and the corresponding image intensity distribution graph 1200 (FIG. 12) appear to indicate that an ELDE, built in accordance with a disclosed embodiment, can provide reduction in RDF image intensity roll off at a cost of reduced image intensity. The reduction in image intensity may be compensated by increasing RDF illuminator intensity and/or microscope camera exposure time.

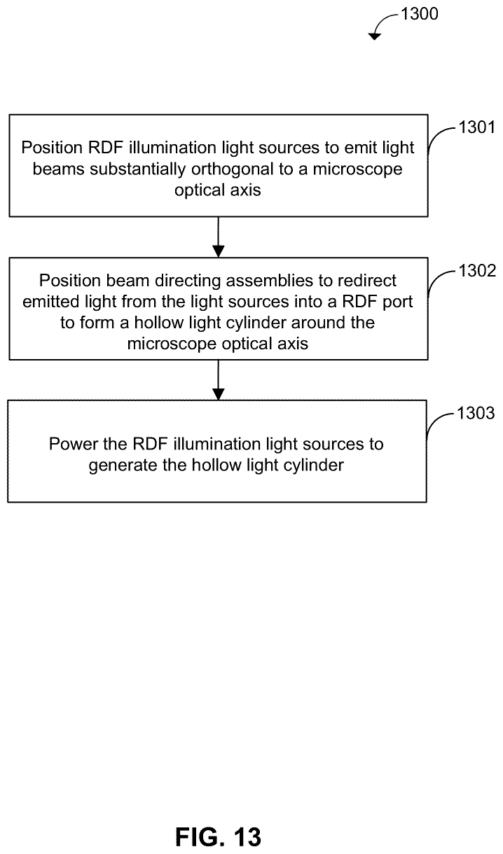

Reference is now made to FIG. 13 showing a flowchart for a method 1300 of generating RDF illumination for a microscope, in accordance with one or more embodiments. Method 1300 may be executed using any suitable apparatus for generating the RDF illumination. For example, method 1300 may be executed using apparatus 200 (FIGS. 2A and 2B), apparatus 500 (FIG. 5), apparatus 600 (FIG. 6) or apparatus 700 (FIG. 7).

At act 1301, one or more RDF illumination light sources may be positioned to emit light beams substantially orthogonal to a microscope optical axis. Any suitable RDF illumination light sources may be used, for example, integrated light sources 300 (FIG. 3) or remote light sources 400 (FIG. 4).

At act 1302, multiple beam directing assemblies may be positioned at substantially identical optical axis distances from a RDF port of a bright field/dark field (BD) objective lens of the microscope to redirect emitted light received from the RDF illumination light sources into the RDF port to form a hollow light cylinder around the microscope optical axis. Any suitable beam directing assembly may be used, for example, beam directing assemblies 204 (FIG. 2) or beam directing assemblies 501 (FIG. 5 or 6).

At act 1303, the RDF illumination light sources may be powered up to generate the hollow light cylinder, wherein the hollow light cylinder is diverted towards a microscope FOV by an ILDE of the microscope positioned within the RDF port. A light sources driver (e.g., light sources driver 202 shown in FIGS. 2 to 6) may be used to control the powering up and down of the RDF illumination light sources.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Items

Item 1: An apparatus for generating reflective dark field (RDF) illumination for a microscope, the apparatus comprising: one or more RDF illumination light sources positioned to emit light beams substantially orthogonal to a microscope optical axis; and multiple beam directing assemblies positioned at substantially identical optical axis distances from an RDF port of a bright field/dark field (BD) objective lens of the microscope, the multiple beam directing assemblies being positioned to redirect emitted light received from the RDF illumination light sources into the RDF port to form a hollow light cylinder around the microscope optical axis, wherein the hollow light cylinder is diverted towards a microscope field of view (FOV) by an internal light diverting element (ILDE) of the microscope positioned within the RDF port.

Item 2: The apparatus of any preceding item, wherein each of the multiple beam directing assemblies includes a fold mirror positioned obliquely to the microscope optical axis to reflect incident light received from a corresponding RDF illumination light source into the RDF port.

Item 3: The apparatus of any preceding item, wherein each of the multiple beam directing assemblies includes a group of fold mirrors, each group including multiple fold mirrors positioned obliquely to the microscope optical axis to reflect incident light from a corresponding RDF illumination light source into the RDF port.

Item 4: The apparatus of any preceding item, further comprising a light intensity equalizer positioned between each RDF illumination light source and corresponding group of fold mirrors.

Item 5: The apparatus of any preceding item, further comprising a collimating lens assembly positioned between each light intensity equalizer and corresponding group of fold mirrors.

Item 6: The apparatus of any preceding item, wherein the multiple beam directing assemblies are positioned in a ring configuration around the microscope optical axis.

Item 7: The apparatus of any preceding item, further comprising a diffuser positioned between the multiple beam directing assemblies and the RDF port.

Item 8: The apparatus of any preceding item, further comprising an external light diverting element (ELDE) attached to the BD objective lens at an end opposite to the RDF port, wherein the ELDE includes: an ELDE lens to focus light from the ILDE at an offset from an object plane of the microscope.

Item 9: The apparatus of any preceding item, wherein the ELDE further includes an ELDE diffuser positioned to diffuse incident light from the ELDE lens towards the microscope FOV.

Item 10: The apparatus of any preceding item, wherein each of the multiple beam directing assemblies includes one or more pairs of beam directing components, each pair including: a beamsplitter positioned to split incident light received from a corresponding RDF illumination light source into a first light portion directed into a first section of the RDF port and a second light portion substantially orthogonal to the microscope optical axis; and a fold mirror positioned opposite to the beamsplitter to reflect the second light portion from the beamsplitter into a second section of the RDF port.

Item 11: The apparatus of any preceding item, wherein each of the multiple RDF illumination light sources includes: a laser diode; and a collimating lens assembly positioned between the laser diode and a corresponding beam directing assembly.

Item 12: The apparatus of any preceding item, wherein each of the multiple RDF illumination light sources includes: an optical head compartment optically coupled to a light engine compartment positioned remotely from the microscope; and a collimating lens assembly positioned between the optical head compartment and a corresponding beam directing assembly.

Item 13: The apparatus of any preceding item, wherein the light engine compartment includes: a first array of laser diodes; a first array of collimating lenses positioned to collimate light emitted by the first array of laser diodes; a first array of fold mirrors positioned to redirect light output from the first array of collimating lenses towards a light focusing assembly; and the light focusing assembly positioned to focus light output from the first array of fold mirrors into an optical coupler connected to the optical head compartment.

Item 14: The apparatus of any preceding item, wherein the light output from the first array of fold mirrors is substantially linearly polarized and the light engine compartment further includes: a polarizing beamsplitter positioned between the first array of fold mirrors and the light focusing assembly that substantially transmits the light output from the first array of fold mirrors to the light focusing assembly; a second array of laser diodes; a second array of collimating lenses positioned to collimate light emitted by the second array of laser diodes; and a second array of fold mirrors positioned to redirect light output from the second array of collimating lenses towards the polarizing beamsplitter, wherein the light output from the second array of fold mirrors is: having orthogonal polarization to the light output from the first array of fold mirrors, and is substantially redirected by the polarizing beamsplitter to the light focusing assembly.

Item 15: The apparatus of any preceding item, wherein the optical coupler is an optical fiber.

Item 16: The apparatus of any preceding item, wherein the light focusing assembly is anamorphic.

Item 17: The apparatus of any preceding item, wherein the light output from the first array of fold mirrors is substantially linearly polarized and the light engine compartment further includes: a half wave plate positioned between the first array of fold mirrors and the light focusing assembly; a polarizing beamsplitter positioned between the half wave plate and the light focusing assembly that substantially transmits light output from the half wave plate to the light focusing assembly; a second array of laser diodes; a second array of collimating lenses positioned to collimate light emitted by the second array of laser diodes; and a second array of fold mirrors positioned to redirect light output from the second array of collimating lenses towards the polarizing beamsplitter, wherein the light output from the second array of fold mirrors is: identical linearly polarized as the light output from the first array of fold mirrors, and is substantially redirected by the polarizing beamsplitter to the light focusing assembly.

Item 18: A method of generating reflective dark field (RDF) illumination for a microscope, the method comprising: positioning one or more RDF illumination light sources to emit light beams substantially orthogonal to a microscope optical axis; positioning multiple beam directing assemblies at substantially identical optical axis distances from an RDF port of a bright field/dark field (BD) objective lens of the microscope to redirect emitted light received from the RDF illumination light sources into the RDF port to form a hollow light cylinder around the microscope optical axis; and powering the one or more RDF illumination light sources to generate the hollow light cylinder, wherein the hollow light cylinder is diverted towards a microscope field of view (FOV) by an internal light diverting element (ILDE) of the microscope positioned within the RDF port.

Item 19: The method of any preceding item, wherein each of the multiple beam directing assemblies includes a fold mirror positioned obliquely to the microscope optical axis to reflect incident light received from a corresponding RDF illumination light source into the RDF port.

Item 20: The method of any preceding item, wherein each of the multiple beam directing assemblies includes a group of fold mirrors, each group including multiple fold mirrors positioned obliquely to the microscope optical axis to reflect incident light from a corresponding RDF illumination light source into the RDF port.

Item 21: The method of any preceding item, further comprising positioning a light intensity equalizer between each RDF illumination light source and corresponding group of fold mirrors.

Item 22: The method of any preceding item, further comprising positioning a collimating lens assembly between each light intensity equalizer and corresponding group of fold mirrors.

Item 23: The method of any preceding item, wherein the multiple beam directing assemblies are positioned in a ring configuration around the microscope optical axis.

Item 24: The method of any preceding item, further comprising positioning a diffuser between the multiple beam directing assemblies and the RDF port.

Item 25: The method of any preceding item, further comprising attaching an external light diverting element (ELDE) to the BD objective lens at an end opposite to the RDF port, wherein the ELDE includes: an ELDE lens to focus light from the ILDE at an offset from an object plane of the microscope.

Item 26: The method of any preceding item, wherein the ELDE further includes an ELDE diffuser positioned to diffuse incident light from the ELDE lens towards the microscope FOV.

Item 27: The method of any preceding item, wherein each of the multiple beam directing assemblies includes one or more pairs of beam directing components, each pair including: a beamsplitter positioned to split incident light received from a corresponding RDF illumination light source into a first light portion directed into a first section of the RDF port and a second light portion substantially orthogonal to the microscope optical axis; and a fold mirror positioned opposite to the beamsplitter to reflect the second light portion from the beamsplitter into a second section of the RDF port.

Item 28: The method of any preceding item, wherein each of the multiple RDF illumination light sources includes: a laser diode; and a collimating lens assembly positioned between the laser diode and a corresponding beam directing assembly.

Item 29: The method of any preceding item, wherein each of the multiple RDF illumination light sources includes: an optical head compartment optically coupled to a light engine compartment positioned remotely from the microscope; and a collimating lens assembly positioned between the optical head compartment and a corresponding beam directing assembly.

We claim:

1. An apparatus for generating reflective dark field (RDF) illumination for a microscope, the apparatus comprising:
one or more RDF illumination light sources positioned to emit light beams substantially orthogonal to a microscope optical axis; and
multiple beam directing assemblies positioned at substantially identical optical axis distances from an RDF port of a bright field/dark field (BD) objective lens of the microscope, the multiple beam directing assemblies being positioned to redirect emitted light received from the RDF illumination light sources into the RDF port to form a hollow light cylinder around the microscope optical axis,
wherein the hollow light cylinder is diverted towards a microscope field of view (FOV) by an internal light diverting element (ILDE) of the microscope positioned within the RDF port.

2. The apparatus of claim 1, wherein each of the multiple beam directing assemblies includes a fold mirror positioned obliquely to the microscope optical axis to reflect incident light received from a corresponding RDF illumination light source into the RDF port.

3. The apparatus of claim 1, wherein each of the multiple beam directing assemblies includes a group of fold mirrors, each group including multiple fold mirrors positioned obliquely to the microscope optical axis to reflect incident light from a corresponding RDF illumination light source into the RDF port.

4. The apparatus of claim 3 further comprising a light intensity equalizer positioned between each RDF illumination light source and corresponding group of fold mirrors.

5. The apparatus of claim 4 further comprising a collimating lens assembly positioned between each light intensity equalizer and corresponding group of fold mirrors.

6. The apparatus of claim 1, wherein the multiple beam directing assemblies are positioned in a ring configuration around the microscope optical axis.

7. The apparatus of claim 1 further comprising a diffuser positioned between the multiple beam directing assemblies and the RDF port.

8. The apparatus of claim 1 further comprising an external light diverting element (ELDE) attached to the BD objective lens at an end opposite to the RDF port, wherein the ELDE includes:
an ELDE lens to focus light from the ILDE at an offset from an object plane of the microscope.

9. The apparatus of claim 8, wherein the ELDE further includes an ELDE diffuser positioned to diffuse incident light from the ELDE lens towards the microscope FOV.

10. The apparatus of claim 1, wherein each of the multiple beam directing assemblies includes one or more pairs of beam directing components, each pair including:
a beamsplitter positioned to split incident light received from a corresponding RDF illumination light source into a first light portion directed into a first section of the RDF port and a second light portion substantially orthogonal to the microscope optical axis; and
a fold mirror positioned opposite to the beamsplitter to reflect the second light portion from the beamsplitter into a second section of the RDF port.

11. The apparatus of claim 1, wherein each of the multiple RDF illumination light sources includes:
a laser diode; and
a collimating lens assembly positioned between the laser diode and a corresponding beam directing assembly.

12. The apparatus of claim 1, wherein each of the multiple RDF illumination light sources includes:
an optical head compartment optically coupled to a light engine compartment positioned remotely from the microscope; and
a collimating lens assembly positioned between the optical head compartment and a corresponding beam directing assembly.

13. The apparatus of claim 12, wherein the light engine compartment includes:
a first array of laser diodes;
a first array of collimating lenses positioned to collimate light emitted by the first array of laser diodes;
a first array of fold mirrors positioned to redirect light output from the first array of collimating lenses towards a light focusing assembly; and
the light focusing assembly positioned to focus light output from the first array of fold mirrors into an optical coupler connected to the optical head compartment.

14. The apparatus of claim 13, wherein the light output from the first array of fold mirrors is substantially linearly polarized and the light engine compartment further includes:
a polarizing beamsplitter positioned between the first array of fold mirrors and the light focusing assembly that substantially transmits the light output from the first array of fold mirrors to the light focusing assembly;
a second array of laser diodes;
a second array of collimating lenses positioned to collimate light emitted by the second array of laser diodes; and
a second array of fold mirrors positioned to redirect light output from the second array of collimating lenses towards the polarizing beamsplitter, wherein the light output from the second array of fold mirrors is:
having orthogonal polarization to the light output from the first array of fold mirrors, and
is substantially redirected by the polarizing beamsplitter to the light focusing assembly.

15. The apparatus of claim 13, wherein the optical coupler is an optical fiber.

16. The apparatus of claim 15, wherein the light focusing assembly is anamorphic.

17. The apparatus of claim 16, wherein the light output from the first array of fold mirrors is substantially linearly polarized and the light engine compartment further includes:
a half wave plate positioned between the first array of fold mirrors and the light focusing assembly;
a polarizing beamsplitter positioned between the half wave plate and the light focusing assembly that substantially transmits light output from the half wave plate to the light focusing assembly;
a second array of laser diodes;
a second array of collimating lenses positioned to collimate light emitted by the second array of laser diodes; and
a second array of fold mirrors positioned to redirect light output from the second array of collimating lenses towards the polarizing beamsplitter, wherein the light output from the second array of fold mirrors is:
identical linearly polarized as the light output from the first array of fold mirrors, and
is substantially redirected by the polarizing beamsplitter to the light focusing assembly.

18. A method of generating reflective dark field (RDF) illumination for a microscope, the method comprising:
positioning one or more RDF illumination light sources to emit light beams substantially orthogonal to a microscope optical axis;
positioning multiple beam directing assemblies at substantially identical optical axis distances from an RDF port of a bright field/dark field (BD) objective lens of the microscope to redirect emitted light received from the RDF illumination light sources into the RDF port to form a hollow light cylinder around the microscope optical axis; and
powering the one or more RDF illumination light sources to generate the hollow light cylinder,
wherein the hollow light cylinder is diverted towards a microscope field of view (FOV) by an internal light diverting element (ILDE) of the microscope positioned within the RDF port.

19. The method of claim 18, wherein each of the multiple beam directing assemblies includes a fold mirror positioned obliquely to the microscope optical axis to reflect incident light received from a corresponding RDF illumination light source into the RDF port.

20. The method of claim 18, wherein each of the multiple beam directing assemblies includes a group of fold mirrors, each group including multiple fold mirrors positioned obliquely to the microscope optical axis to reflect incident light from a corresponding RDF illumination light source into the RDF port.

21. The method of claim 20 further comprising positioning a light intensity equalizer between each RDF illumination light source and corresponding group of fold mirrors.

22. The method of claim 21 further comprising positioning a collimating lens assembly between each light intensity equalizer and corresponding group of fold mirrors.

23. The method of claim 18, wherein the multiple beam directing assemblies are positioned in a ring configuration around the microscope optical axis.

24. The method of claim 18 further comprising positioning a diffuser between the multiple beam directing assemblies and the RDF port.

25. The method of claim 18 further comprising attaching an external light diverting element (ELDE) to the BD objective lens at an end opposite to the RDF port, wherein the ELDE includes:
an ELDE lens to focus light from the ILDE at an offset from an object plane of the microscope.

26. The method of claim 25, wherein the ELDE further includes an ELDE diffuser positioned to diffuse incident light from the ELDE lens towards the microscope FOV.

27. The method of claim 18, wherein each of the multiple beam directing assemblies includes one or more pairs of beam directing components, each pair including:
a beamsplitter positioned to split incident light received from a corresponding RDF illumination light source into a first light portion directed into a first section of the RDF port and a second light portion substantially orthogonal to the microscope optical axis; and
a fold mirror positioned opposite to the beamsplitter to reflect the second light portion from the beamsplitter into a second section of the RDF port.

28. The method of claim 18, wherein each of the multiple RDF illumination light sources includes:
a laser diode; and
a collimating lens assembly positioned between the laser diode and a corresponding beam directing assembly.

29. The method of claim 18, wherein each of the multiple RDF illumination light sources includes:
an optical head compartment optically coupled to a light engine compartment positioned remotely from the microscope; and
a collimating lens assembly positioned between the optical head compartment and a corresponding beam directing assembly.
